(19) United States
(12) Patent Application Publication
(10) Pub. No.: US 2004/0026176 A1
(43) Pub. Date: Feb. 12, 2004

(54) Drive-thru window advertising system

(76) Inventor: Chris Quinlan, Greenville, DE (US)

Correspondence Address: RatnerPrestia, Nemours Building, 1007 Orange Street, Suite 1100, P.O. Box 1596, Wilmington, DE, 19899, US

(21) Appl. No.: 10/436,840

(22) Filed: May 13, 2003

Related U.S. Application Data
(60) Provisional application No. 60/380,492, filed on May 14, 2002.

(51) Int. Cl. B61B 1/00; B65G 1/00; E04H 3/00

(52) U.S. Cl. 186/53

(57) ABSTRACT

An advertising system for encouraging impulse purchases of non-prescription products or services at a drive-thru window. The system comprises a drive-thru window, having an interior and an exterior, where customers pick-up prescription products. One or more advertising signs with changeable advertising copy promoting one or more non-prescription products or services are visible from a vehicle waiting in line at or approaching the exterior of the drive-thru window. A set of storage devices is positioned in close proximity to the interior of the drive-thru window and readily accessible by an operator of the drive-thru window. Each storage device contains one of the non-prescription products or items related to one of the non-prescription services corresponding to the changeable advertising copy.

### CROSS REFERENCE TO RELATED APPLICATIONS

This application claims priority from U.S. Provisional Application No. 60/380,492, filed May 14, 2002, incorporated herein by reference.

### FIELD OF THE INVENTION

This invention relates generally to advertising methods and systems, and specifically to advertising methods and systems for use with pharmacy drive-thru windows.

### BACKGROUND OF THE INVENTION

Pharmacy drive-thru windows are becoming an increasingly popular offering for pharmacies worldwide. While drive-thru windows provide advantages for the consumer, who never has to leave his or her car, the drive-thru deprives the pharmacy of a potential opportunity to make other product sales while the consumer browses the store while waiting for the prescription to be filled. While fast food restaurant drive thru windows typically provide a menu of choices remote from the window so that the customer can order in one location and then have his or her food ready by the time he or she gets to the window, pharmacies do not operate in this fashion. Because filling a prescription typically takes a long time, the consumer (or consumer's physician) typically places a telephone order for the prescription, and then the consumer drives to pick up the order later. Thus, there is no ordering from a menu of choices at a pharmacy drive-thru window.

Even if a drive-thru customer wanted to order one of the various non-prescription items available in the store, it would be burdensome for the pharmacist to retrieve such an item from the store. As a result, the drive-thru window, while a convenience for customers, is not a source of incidental income for pharmacies attributable to the “impulse purchases” that consumers may make when waiting in line inside the retail store. For example, it is common for retail stores to include displays of items such as candy, gum, film, video tapes (prerecorded and blank), musical recordings, cosmetics, internet dial-up services, phone cards, and the like, near the cash register in hopes that a consumer seeing such an item will have an impulse to buy it.

Thus, there is a need in the art for retailers of prescription products, to provide an advertising and fulfillment system to facilitate impulse purchases at their drive-thru windows.

### SUMMARY OF THE INVENTION

The present invention takes advantage of the time that a consumer spends in a drive-thru line and provides a way for pharmacies to facilitate impulse buys among customers waiting for prescriptions to be filled. Thus, one aspect of the invention comprises an advertising system for encouraging impulse purchases of non-prescription products or services at a drive-thru window. The system comprises a drive-thru window, having an interior and an exterior, where customers pick-up prescription products; at least one advertising sign with changeable advertising copy visible from a vehicle waiting in line at or approaching the exterior of the drive-thru window, the changeable advertising copy promoting one or more non-prescription products or services; and a set of storage devices positioned in close proximity to the interior of the drive-thru window and readily accessible by an operator of the drive-thru window. Each storage device contains one of the non-prescription products or items related to one of the non-prescription services corresponding to the changeable advertising copy. An “item related to a non-prescription service” may comprise, for example, a disk to be used for installing an Internet dial-up service, a phone card for use in accessing long-distance service, or the like. The advertising sign may comprise a plurality of slots for holding units of advertising copy and may be illuminated.

In one embodiment, the advertising sign comprises an enclosure having a wall-mounting surface in a first plane, a changeable-advertising-copy-mounting surface in a second plane angled relative to the first plane; and a door comprising a door frame and a window through which the advertising copy is visible.

In another embodiment, the advertising sign comprises a corner-mounted sign comprising an enclosure having two wall-mounting surfaces in intersecting first and second planes for mounting to a corner of a building, two changeable-advertising-copy-mounting surfaces, one of which is in a third plane parallel to the first plane and another of which is angled relative to the second plane; and one or more doors, each comprising a door frame and a window through which the advertising copy is visible.

Another aspect of the invention comprises a method for increasing revenue generated from a pharmacy drive-thru window where customers pick-up prescription products. The method comprises positioning an advertising sign with changeable advertising copy visible from a vehicle waiting in line at or approaching an exterior of the drive-thru window and positioning a set of storage devices in close proximity to the interior of the drive-thru window where they are readily accessible by an operator of the drive-thru window. Each storage device contains one of the non-prescription products or items related to one of the non-prescription services corresponding to the changeable advertising copy. Manufacturers or distributors of the non-prescription products or services are charged for placing advertisements on the advertising signs. The advertising copy is preferably changed on a periodic basis, such as weekly, monthly, seasonally, or whenever desired by the retailer or manufacturer/distributor.

Yet another aspect of the invention comprises an advertising method for encouraging impulse purchases of products or services at a drive-thru window. The method comprises providing a drive-thru window, having an interior and an exterior, where customers pick-up ordered products or serviced goods pursuant to an order placed from a remote location prior to the customer's approach to the drive-thru window. At least one advertising sign with changeable advertising copy is placed in a location visible from a vehicle waiting in line at or approaching the exterior of the drive-thru window. The changeable advertising copy promotes one or more products or services that was not advertised for ordering at the remote location. A set of storage devices is positioned in close proximity to the interior of the drive-thru window where it is readily accessible by an operator of the drive-thru window. Each storage device contains one of the products or items related to one of the services corresponding to the changeable advertising copy.

### BRIEF DESCRIPTION OF THE DRAWINGS

FIG. 1 depicts a drive-thru window outfitted with an exemplary advertising system of the present invention comprising a plurality of advertising signs;

FIG. 2A is a detailed illustration of one embodiment of the exemplary advertising signs depicted in FIG. 1;

FIG. 2B is a detailed illustration of another embodiment of the exemplary advertising signs depicted in FIG. 1;

FIG. 3 depicts an exemplary corner-mounted advertising sign;

FIG. 4 shows two exemplary sets of storage devices in close proximity to the interior of the drive-thru window; and

FIG. 5 shows another exemplary set of advertising signs for use with the present invention.

### DETAILED DESCRIPTION OF THE INVENTION

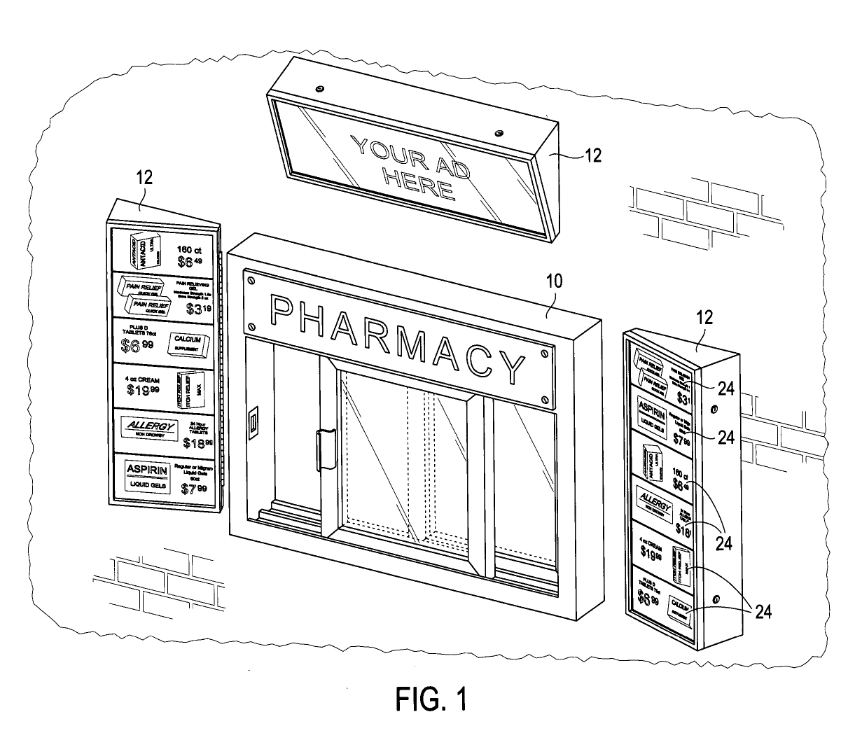

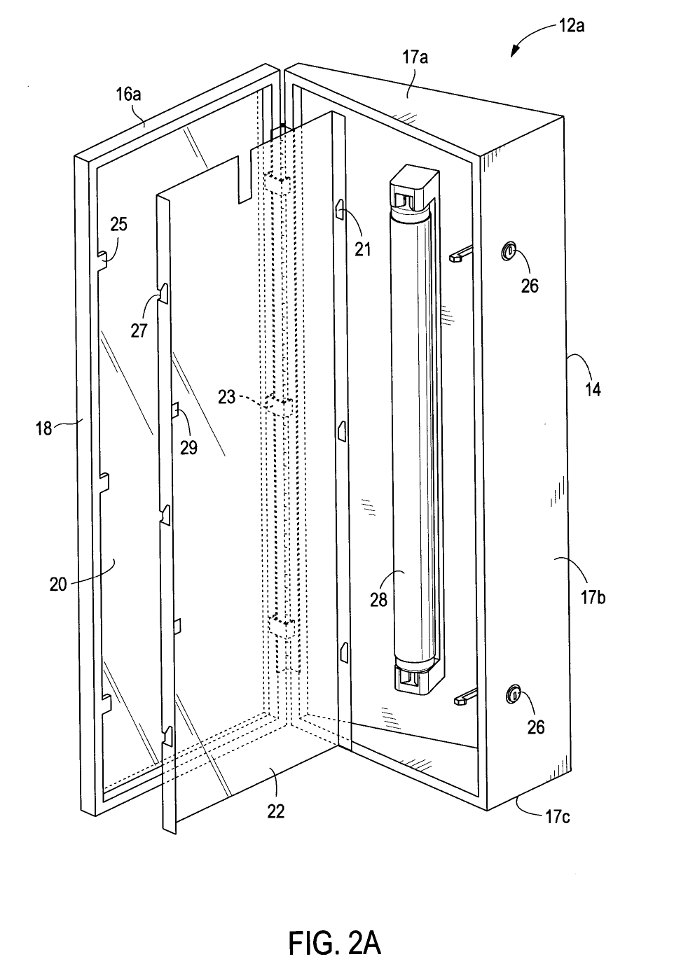

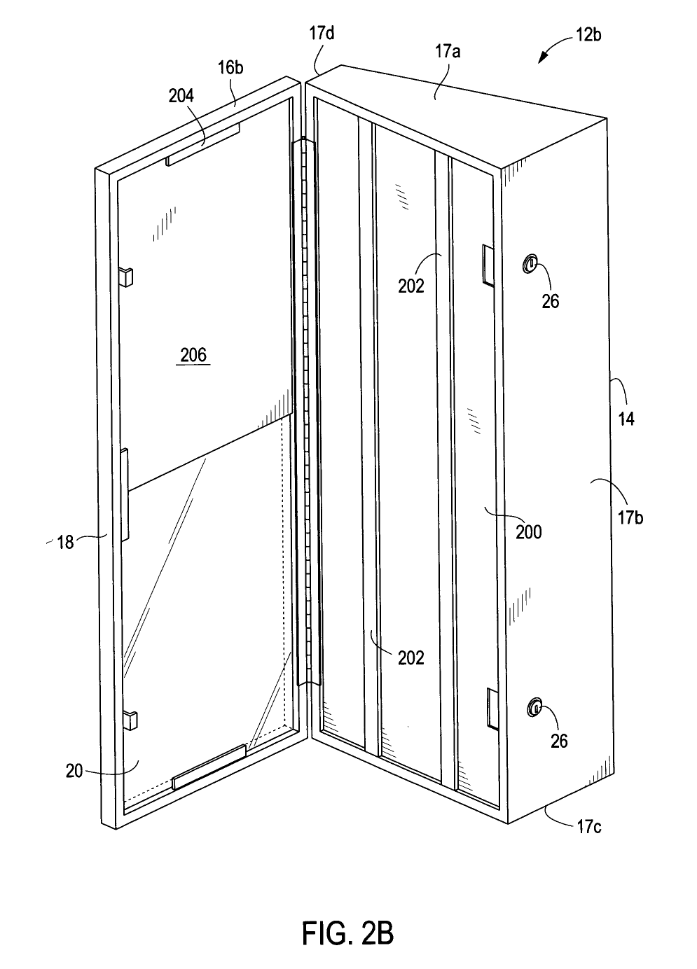

Referring now to the drawing, FIG. 1 shows an exemplary drive-thru window 10 having advertising signs 12 mounted on the left-hand side, right-hand side, and above the window. Each of the advertising signs 12 may be identical or nearly identical, with the only difference being in their mounting orientation on the building. FIGS. 2A and 2B show more detailed views of exemplary sign boxes 12a and 12b, respectively.

Sign 12a, as shown in FIG. 2A, comprises an enclosure defined by wall-mounting surface 14 for mounting the sign to the wall, a hinged door 16a which lies along a plane that is angled with respect to the plane of the mounting surface, and side walls 17a, 17b, and 17c. An additional side wall may be positioned parallel to side wall 17b between the mounting surface 14 and the hinged door 16a (such as is shown in FIG. 2B). Hinged door 16a comprises a frame 18 and a transparent window 20, which may comprise any transparent material known in the art, preferably a weatherproof material. Copy holder 22 is adapted to secure individual units of advertising copy 24 (shown in FIG. 1) between the copy holder 22 and the transparent window 20, parallel to the window. Although 6 units of advertising copy 24 are shown on each sign in FIG. 1. The signs may accommodate any number of advertising units. Multiple advertising units may be grouped together on a single sheet or two sheets of paper or cardstock for ease of handling, or may comprise individual sheets. The sheets may be temporarily attached to the copy holder, such as with a double-sided tape or a glue spray, or may be held in place with a clip or tab 29 on the front of the copy holder, while the sign is being loaded.

To compress the advertising copy against the window before the door is closed, holes 21 engage prongs 23 on one side of the copy holder and the copy holder is pivoted until tabs 25 engage slots 27 on the opposite side. Flexibility in the prongs 23 provides spring-loading, and flexibility in frame 18 provides the ability to deform the frame sufficiently to snap the tabs into place so that the copy holder is held between the window and the tabs until the frame is deformed again sufficiently for the tabs to clear the slots. Locks 26 secure the door in a closed position.

Copy holder 22 may be opaque for a sign that is not illuminated at all or illuminated from the front, or the copy holder may be translucent for a backlit sign. Where copy holder is translucent, a light source 28, such as a fluorescent, incandescent, or other type of light bulb mounted in the enclosure, as is well known in the art of illuminated sign boxes, thereby making the advertising copy visible to the customer even under poor ambient light conditions.

The individual units of advertising copy may comprise, for example, sheets of plastic or paper (which are preferably semi-translucent or semi-transparent, if the sign is backlit), cardboard, metal, or the like. Each sign preferably comprises a plurality of advertising slots rented to manufacturers or distributors of the products or services to be advertised. Each “slot” may be a physical slot for holding an individual advertisement, or an allotted portion of a continuous sheet comprising a plurality of advertisements. Thus, customers may view advertisements while waiting in line, and then place an order for the advertised product at the window, thereby receiving the additional advertised “impulse purchase” simultaneously with the sale of the prescription item.

Preferably, the advertising sign structures are universally adaptable for mounting in association with any drive-thru design. Even if a plurality of different structural systems are offered, it is advantageous to make the advertising slots for receiving the units of advertising copy consistent from design to design. In this manner, for example, a nationwide pharmacy chain may choose to outfit a large number of its drive-thru windows with advertising systems that are nearly identical, or that at least that have interchangeable units of advertising copy. Thus, the individual units of advertising copy can be mass produced and sent to a plurality of stores in a coordinated program.

Another sign enclosure design 12b is shown in FIG. 2B. This design is particularly advantageous for applications where backlighting is not desired. In this application, a front wall 200 is integrated into the structure of the sign. Front wall 200 preferably has one or more compressible members, such as foam rubber strips 202 shown in FIG. 2B. Frame 18 of door 16b preferably comprises one or more clips 204, for holding sheets 206 of advertising copy. The advertising copy slips between each clip 204 and the window 20 such that the clip holds the sheet next to the window. Although shown with a total of 4 clips, any number of clips may be used. FIG. 2B is illustrated with a top sheet loaded, and a bottom sheet removed to reveal the window underneath. Although shown with two sheets of advertising copy, a single sheet or more than two sheets may be used. The number of sheets used will, in part, determine the number of clips required. After the copy is put in place to be held by the clips, the door is closed, and the compressible members are compressed with the door closed to provide a force to hold sheets 206 of advertising copy in contact with window 20. Although shown with compressive strips, the compressive members may be of any geometry, including covering the entire surface of front wall 200.

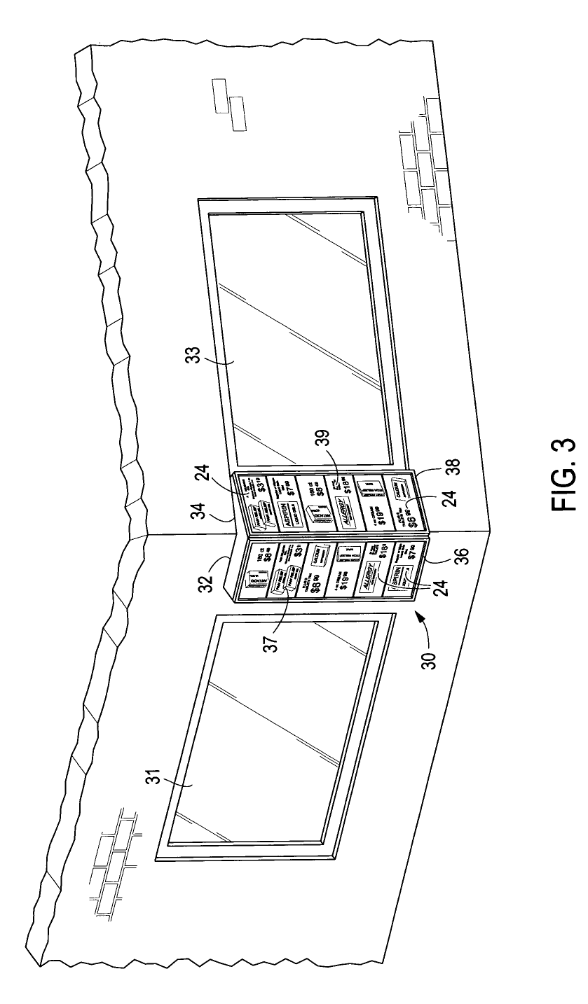

FIG. 3 shows an exemplary advertising sign 30 for mounting on a corner of a building. This structure may be similar to those shown in FIGS. 2A or 2B, except that it comprises two wall-mounting surfaces 32 and 34 that intersect at a right angle for mounting to a corner of a building. The corner-mounted sign may have two doors 36 and 38, each similar to door 16a or 16b, or a single door having two windows 37 and 39. In a design similar to FIG. 2A, each window has a copy holder 22 associated with it, whereas in a design similar to FIG. 2B, each door has one or more clips 204 for holding advertising copy. Window 37 may be positioned in a plane parallel to mounting surface 32, and window 39 positioned in a plane angled relative to mounting surface 34. Each copy holder is parallel to its associated window. The corner mounted system may be particularly advantageous for use in a two-window corner pharmacy drive-thru arrangement where a first window 31 may be for placing an order, and a second window 33 may be for receiving a filled order.

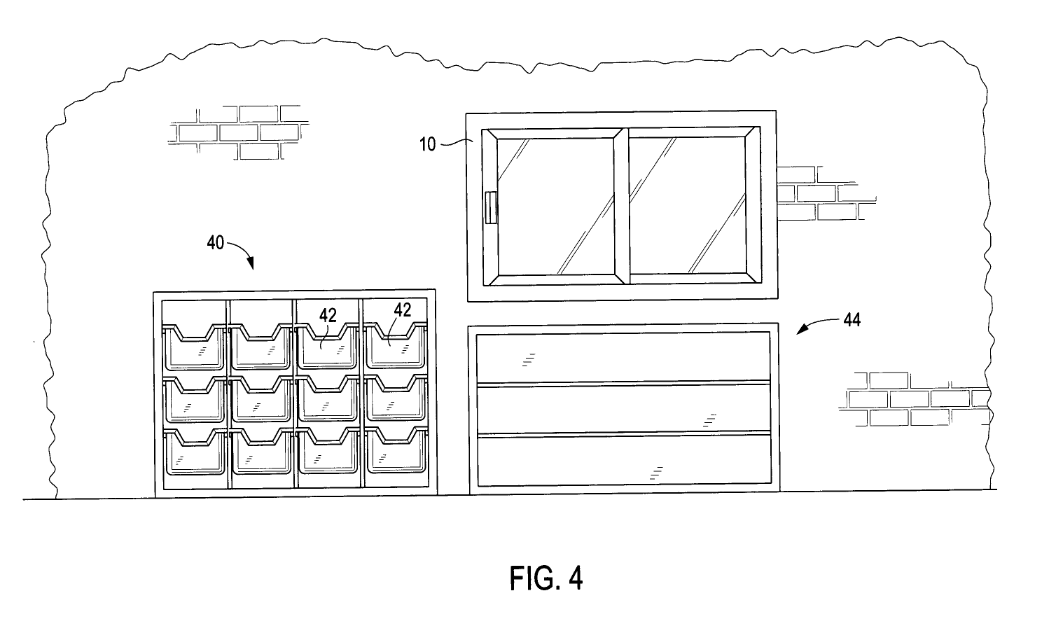

It is important, particularly in a drive-thru situation, to provide quick access to the advertised products by the attendant working at the drive-thru window. Accordingly, a set of storage devices is preferably placed on the interior of the drive-thru window where it is readily accessible by the attendant. For example, as shown in FIG. 4, a set 40 of product bins or baskets 42 may be provided next to or in close proximity to the window. Each basket 42 contains one of the products or items associated with the services advertised by the advertising copy. Instead of bins or baskets, however, a dedicated section of shelving unit 44 or some other storage device may be used. The invention is not limited to any particular type of storage device.

By “close proximity,” it is meant that the set of storage devices is close enough to the interior of drive-thru window that the drive-thru attendant does not have to travel all the way to the normal stock location of the item to retrieve it for the drive-thru patron. For example, in a pharmacy setting, the pharmacy area is typically separated by a counter or divider from the rest of the retail store. The set of storage devices is preferably positioned close enough to the drive-thru window that the attendant-does not have to leave the area behind the divider, and more preferably close enough that the average-adult sized attendant does not have to stop away from the window more than three to five steps to reach the stored items. In one preferred embodiment, shown in FIG. 4, the set of storage devices may comprise a shelving unit 44 located directly below the window. Non-pharmacy drive-thru pick-up windows may be similarly set off from the rest of the retail location by some type of divider or may otherwise have a dedicated workspace associated with the drive-thru window. Placement of the set of storage devices in the dedicated workspace puts them in close enough proximity to the drive-thru window for easy access by the attendent.

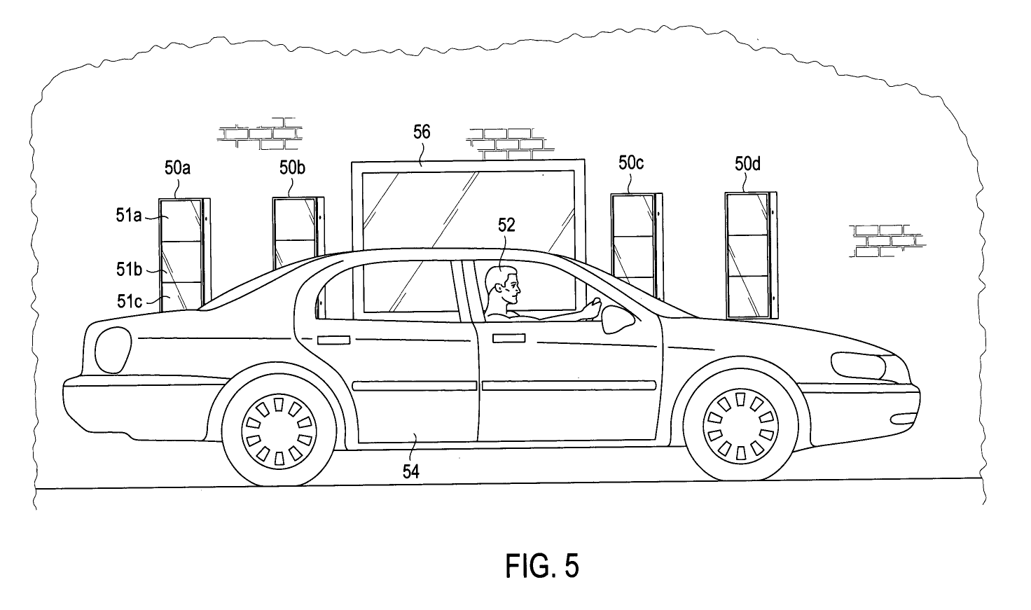

Although shown and described in detail with respect to the embodiments shown in FIGS. 1-3, the methods and system of the present invention may also be used in conjunction with any type of advertising sign. FIG. 5, for example, shows a plurality of vertical three-slot sign structures 50a-50d, each of which can hold up to three advertisements 51a, 51b, and 51c, one in each advertising slot. Sign structures 50a and 50b are visible by customer 52 in his vehicle 54 when the vehicle is in a position approaching drive-thru window 56, whereas sign structures 50c and 50d are visible when the vehicle is at the drive-thru window. One or more units of advertising copy may also be provided on the inside of the pharmacy window itself. Rather than signs comprising multiple advertising slots, designs may be provided with one advertising slot per sign. In one embodiment, the storage devices may comprise shelves mounted in the window, readily accessible from inside the pharmacy, stocked with the actual products that are visible through the window, in which case the advertising copy may comprise the labels on the products in the storage devices.

It should be recognized that although a preferred embodiment is to sell non-prescription products using the advertising, because of the desirability of promoting sales that can be immediately consummated by the consumer, some of the advertisement slots may also be used for promoting prescription products as well. For example, an allergy medicine may be advertised during allergy season to make a customer waiting in line aware of its availability the next time he or she visits his or her doctor. Similarly, some advertising slots may be used by the pharmacy or by manufacturers for promoting charities or general corporate goodwill.

Also, it should be understood that although shown with multi-slot structures capable of containing separate and distinct units of advertising copy, a single advertisement may span multiple spots. Similarly, multiple products may be promoted in a single slot, or for example, a slot located between two other slots may be provided with a split advertisement that includes a portion that relates to each of the adjacent slots.

Finally, there is no limit to the types of non-prescription products or services that may be used in conjunction with the present invention, nor is there any limit to the types of drive-thru windows in conjunction with which the present invention may be used. For example, although particularly beneficial for use with pharmacy drive-thru windows, where the prescription products are typically pharmaceutical products, other types of drive-thru windows are known. For example, a prescription eyewear drive-thru window may advertise eyeglass cases, eyeglass cleaning products, and the like using the present invention. A drive-thru dry cleaner may use an analogous advertising system for advertising products or services other than dry cleaning services, such as for example, clothing care products. A food service drive-thru may advertise non-food products or services that are not advertised at the remote location where the food order is placed. What is important, is that the advertisement relates to a product or service that is not the typical product or service for which a customer uses the drive-thru window, or relates to a product that is not available or not advertised as being available for ordering remotely from the drive-thru window. Advertisement of such products or services thus encourage the customer is to make an impulse purchase.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A marketing system for encouraging impulse purchases of non-prescription products or services at a drive-thru window, the system comprising:
a drive-thru window, having an interior and an exterior, where customers pick-up prescription products;
one or more advertising signs with changeable advertising copy visible from a vehicle waiting in line at or approaching the exterior of the drive-thru window, the changeable advertising copy promoting one or more non-prescription products or services;
a set of storage devices positioned in close proximity to the interior of the drive-thru window and readily accessible by an operator of the drive-thru window, each storage device containing one of the non-prescription products or items related to one of the non-prescription services corresponding to the changeable advertising copy.

2. The marketing system of claim 1, wherein each of the one or more advertising signs comprises an enclosure having a wall-mounting surface in a first plane, a changeable-advertising-copy-mounting surface in a second plane angled relative to the first plane; and a door comprising a door frame and a window through which the advertising copy is visible.

3. The marketing system of claim 1, wherein each of the one or more advertising signs comprises a corner-mounted sign comprising an enclosure having two wall-mounting surfaces in intersecting first and second planes for mounting to a corner of a building, two changeable-advertising-copy-mounting surfaces, one of which is in a third plane parallel to the first plane and another of which is angled relative to the second plane; and one or more doors, each comprising a door frame and a window through which the advertising copy is visible.

4. The marketing system of claim 1, wherein at least one of the one or more advertising signs is illuminated.

5. The marketing system of claim 1, wherein the one or more advertising signs are mounted to the left of the drive-thru window, to the right of the drive-thru window, above the drive-thru window, or a combination thereof.

6. The marketing system of claim 1, wherein the set of storage devices comprises a set of storage bins.

7. The marketing system of claim 1, wherein the set of storage devices is located no more than five steps of an average-sized adult away from the window.

8. The marketing system of claim 1, wherein the set of storage devices comprises a shelving unit or portion of a shelving unit.

9. The marketing system of claim 8, wherein the shelving unit is located directly below the drive-thru window.

10. A method for increasing revenue generated from a pharmacy drive-thru window where customers pick-up prescription products, the method comprising:
(a) positioning an advertising sign with changeable advertising copy visible from a vehicle waiting in line at or approaching an exterior of the drive-thru window having, the changeable advertising copy promoting one or more non-prescription products or services;
(b) placing a set of storage devices positioned in close proximity to the interior of the drive-thru window and readily accessible by an operator of the drive-thru window, each storage device containing one of the non-prescription products or items related to one of the non-prescription services corresponding to the changeable advertising copy;
(c) charging manufacturers or distributors of the non-prescription products or services for placing advertisements on the advertising signs.

11. The method of claim 10, further comprising changing the advertising copy on a periodic basis.

12. A method of advertising for encouraging impulse purchases of products or services at a drive-thru window, the method comprising the steps of:
providing a drive-thru window, having an interior and an exterior, where customers pick-up ordered products or serviced goods pursuant to an order placed from a remote location prior to the customer's approach to the drive-thru window;
placing at least one advertising sign with changeable advertising copy in a position visible from a vehicle waiting in line at or approaching the exterior of the drive-thru window, the changeable advertising copy promoting one or more products or services not advertised for ordering at the remote location; and
placing a set of storage devices positioned in close proximity to the interior of the drive-thru window and readily accessible by an operator of the drive-thru window, each storage device containing one of the products or items related to one of the services corresponding to the changeable advertising copy.

13. The method of claim 12, wherein the drive-thru window comprises a pharmacy drive-thru window and the ordered products comprise prescription pharmaceutical products, the method comprising advertising non-prescription products or items related to non-prescription services using the changeable advertising copy.

14. The method of claim 12, wherein the drive-thru window comprises a drive-thru window associated with prescription eyewear and the ordered products comprise prescription eyewear, the method comprising advertising non-prescription products or items related to non-prescription services using the changeable advertising copy.

15. The method of claim 12, wherein the drive-thru window comprises a drive-thru window associated with a dry cleaner, the method comprising providing a window for picking up cleaned goods belonging to the customer and advertising products or services other than dry cleaning services.

16. The method of claim 12, wherein the drive-thru window comprises a food service drive-thru window comprising a location remote from the window for placing food orders, the method comprising using the changeable advertising copy to advertise non-food products or non-food items related to services that are not advertised at the location remote from the window for placing food orders.
